(19) United States
(12) Patent Application Publication
(10) Pub. No.: US 2026/0193501 A1
(43) Pub. Date: Jul. 9, 2026

(54) DIANHYDROHEXITOL TACKIFYING AGENT AND HOT MELT ADHESIVE COMPOSITIONS INCLUDING THE SAME

(71) Applicant: H.B. Fuller Company, St. Paul, MN (US)

(72) Inventors: Thomas F. Kauffman, Woodbury, MN (US); Kevin P. Davis, Woodbury, MN (US); Adam M. Pederson, Blaine, MN (US); Zhiyong Gan, Beijing (CN); Allen Yang, Beijing (CN); Dan Su, Beijing (CN)

(21) Appl. No.: 18/868,376

(22) PCT Filed: May 23, 2023
(86) PCT No.: PCT/US2023/067348

§ 371 Date: Nov. 22, 2024

Related U.S. Application Data
(60) Provisional application No. 63/365,183, filed on May 23, 2022.

(51) Int. Cl. C09J 167/02; B32B 7/12; B32B 29/00; C08G 63/672

(52) U.S. Cl. CPC C09J 167/02; B32B 7/12; B32B 29/005; C08G 63/672; B32B 2250/02; B32B 2307/7163

(57) ABSTRACT

Disclosed is a dianhydrohexitol tackifying agent and a hot melt adhesive composition including the same. The dianhydrohexitol tackifying agent includes the reaction product of dianhydrohexitol, a diacid component, optionally a difunctional reactant, and optionally a monofunctional end capping agent, the dianhydrohexitol tackifying agent exhibiting a glass transition temperature of from 0° C. to 120° C., or even from 30° C. to 100° C., a weight average molecular weight of no greater than 6000, and an acid number no greater than 50 mg KOH/g.

### CROSS REFERENCE TO RELATED APPLICATIONS

This application claims the benefit of U.S. Provisional Application No. 63/365,183, filed May 23, 2022, which is incorporated herein.

### BACKGROUND

The invention is directed to dianhydrohexitol tackifying agents and formulating hot melt adhesive compositions that include the same.

Hot melt adhesive compositions are often formulated with a thermoplastic polymer and a tackifying agent. For a hot melt adhesive composition to be useful, the components that make up the composition should be compatible with one another and free of phase separation both at room temperature and when heated to the application temperature.

There is a growing interest in using components that are obtained from renewable resources (i.e., resources other than petroleum) and that are biodegradable, or ideally industrially compostable, when formulating hot melt adhesive compositions. For such components to be suitable for use in a hot melt adhesive composition, they must be compatible with the other components of the adhesive composition.

Isosorbide, which can be derived from starch, has been disclosed as being a suitable monomer unit for forming tackifiers. A wide range of possible molecules that incorporate isosorbide have been proposed.

Monomers that are derived from renewable resources are not inherently biodegradable or industrially compostable. Likewise, oligomers and polymers prepared from monomers derived from renewable resources are not inherently biodegradable or industrially compostable.

There is a need for polymer compositions that are derived from renewable resources. There is also a need for polymer compositions that are biodegradable or even industrially compostable.

### SUMMARY

In one aspect, the invention features a hot melt adhesive composition that includes from 3% by weight to 90% by weight polymer, and from 10% by weight to 80% by weight of a dianhydrohexitol tackifying agent comprising the reaction product of dianhydrohexitol, a diacid component selected from the group consisting of dicarboxylic acid, cyclic anhydride, and combinations thereof, optionally a difunctional reactant selected from the group consisting of cyclic esters, hydroxy acids, and combinations thereof, when the difunctional reactant is present, the dianhydrohexitol tackifying agent has a molar ratio of dianhydrohexitol to difunctional reactant of greater than one, and optionally a monofunctional end capping agent, the dianhydrohexitol tackifying agent exhibiting a glass transition temperature (Tg) of from 0° C. to 120° C., or even from 30° C. to 100° C., a weight average molecular weight of no greater than 6000, and an acid number no greater than 50 mg KOH/g. In one embodiment, the dianhydrohexitol tackifying agent includes the reaction product of the dianhydrohexitol, the diacid component, and the difunctional reactant. In some embodiments, the difunctional reactant is selected from the group consisting of lactide, lactic acid, caprolactone, 6-hydroxy caproic acid, glycolic acid, 3-hydroxy pentanoic acid, 3-hydroxy butyric acid, 4-hydroxy butyric acid, and combinations thereof. In one embodiment, the difunctional reactant includes lactide, lactic acid, or a combination thereof. In some embodiments, the diacid component includes succinic acid, succinic anhydride, or a combination thereof and the difunctional reactant includes lactide, lactic acid, or a combination thereof. In other embodiments, the dianhydrohexitol includes isosorbide, the diacid component includes succinic acid, succinic anhydride, or a combination thereof, and the difunctional reactant includes lactide, lactic acid, or a combination thereof.

In another embodiment, the dianhydrohexitol tackifying agent includes the reaction product of the dianhydrohexitol, the diacid component, and the monofunctional end capping agent.

In some embodiments, the polymer is selected from the group consisting of ethylene polar comonomer copolymer, polylactic acid, polyglycolide, polyhydroxyalkanoate, polyurethane, poly(butylene adipate terephthalate), poly(butylene succinate), polycaprolactone, polycaprolactone copolymers, polyester-polyether copolymer, acrylates, and combinations thereof.

In other embodiments, the dianhydrohexitol tackifying agent is hydroxy functional.

In other embodiments, the dianhydrohexitol tackifying agent has an acid number less than 30 mg KOH/g.

In one embodiment, the dianhydrohexitol tackifying agent has an acid number less than 10 mg KOH/g.

In another embodiment, the diacid component is selected from the group consisting of oxalic acid, glutaric acid, maleic acid, succinic acid, succinic anhydride, glutaric anhydride, maleic anhydride, 1,4-cyclohexyl dicarboxylic acid, malonic acid, adipic acid, hexahydrophthalic acid, isophthalic acid, terephthalic acid, phthalic acid, phthalic anhydride, and combinations thereof.

In some embodiments, the diacid component includes succinic acid, succinic anhydride, or a combination thereof.

In one embodiment, the hot melt adhesive composition comprises from 10% by weight to 50% by weight of the dianhydrohexitol tackifying agent.

In other embodiments, the polymer includes ethylene vinyl acetate and the composition comprises from 30% by weight to 80% by weight of the dianhydrohexitol tackifying agent.

In another embodiment, the polymer includes polylactic acid and the hot melt adhesive composition includes from 10% by weight to 60% by weight of the dianhydrohexitol tackifying agent.

In some embodiments, the dianhydrohexitol tackifying agent exhibits a Tg of from 30° C. to 70° C.

In other embodiments, the dianhydrohexitol tackifying agent is derived from at least 20% by weight dianhydrohexitol based on the molecular weight of the dianhydrohexitol tackifying agent.

In another embodiment, the hot melt adhesive composition exhibits at least 20% biodegradation at 60 days when tested according to the Biodegradation Test Method. In another embodiment, the hot melt adhesive composition exhibits at least 50% biodegradation at 60 days when tested according to the Biodegradation Test Method. In other embodiments, the hot melt adhesive composition exhibits at least 80% biodegradation at 90 days when tested according to the Biodegradation Test Method. In some embodiments, the hot melt adhesive composition exhibits at least 90% biodegradation at 180 days when tested according to the Biodegradation Test Method. In another embodiment, the hot melt adhesive includes at least 90% biogenic carbon as determined according to the New Carbon Content Test Method.

In some embodiments, the dianhydrohexitol includes isosorbide.

In some embodiments the dianhydrohexitol tackifying agent exhibits at least 20% biodegradation at 60 days when tested according to the Biodegradation Test Method.

In another aspect, the invention features a thermoplastic polymer composition that includes from 50% by weight to 99% by weight of a polymer selected from the group consisting of polylactic acid, polyglycolide, polyhydroxyalkanoate, polyurethane, poly(butylene adipate terephthalate), poly(butylene succinate), polycaprolactone, ethylene-polar comonomer copolymer, polyester-polyether copolymer, acrylate, methacrylate, and combinations thereof; and from 1% by weight to 50% by weight dianhydrohexitol additive, the dianhydrohexitol additive having a weight average molecular weight of no greater than 6000 g/mole and a glass transition temperature of from 0° C. to 120° C., or even from 30° C. to 100° C., and including the reaction product of dianhydrohexitol, a diacid component selected from the group consisting of dicarboxylic acid, cyclic anhydride, and combinations thereof, optionally a difunctional reactant selected from the group consisting of cyclic ester, hydroxy acid, and combinations thereof, and optionally a monofunctional end capping agent, the dianhydrohexitol additive having a molar ratio of dianhydrohexitol to the difunctional reactant of greater than 1 when the difunctional reactant is present and an acid number no greater than 50 mg KOH/g. In one embodiment, the polymer composition exhibits at least 20% biodegradation at 60 days when tested according to the Biodegradation Test Method. In some embodiments, the polymer composition exhibits at least 50% biodegradation at 60 days when tested according to the Biodegradation Test Method. In another embodiment, the polymer composition exhibits at least 80% biodegradation at 90 days when tested according to the Biodegradation Test Method. In other embodiments, the polymer composition exhibits at least 90% biodegradation at 180 days when tested according to the Biodegradation Test Method.

In other aspects, the invention features a dianhydrohexitol tackifying agent that includes the reaction product of dianhydrohexitol, a diacid component selected from the group consisting of dicarboxylic acid, cyclic anhydride, and combinations thereof, a difunctional reactant selected from the group consisting of cyclic ester, hydroxy acid, and combinations thereof, and optionally a monofunctional end capping agent, the dianhydrohexitol tackifying agent including at least 20% by weight dianhydrohexitol, having a molar ratio of dianhydrohexitol to difunctional reactant of greater than one, and exhibiting a glass transition temperature of from 0° C. to 120° C., or even from 30° C. to 100° C., a weight average molecular weight of no greater than 6000 g/mole, and an acid number of no greater than 50 mg KOH/g. In one embodiment, the difunctional reactant is selected from the group consisting of lactide, lactic acid, caprolactone, 6-hydroxy caproic acid, glycolic acid, 3-hydroxy pentanoic acid, 3-hydroxy butyric acid, 4-hydroxy butyric acid, and combinations thereof. In another embodiment, the difunctional reactant includes lactide, lactic acid, or a combination thereof. In some embodiments, the diacid component includes succinic acid, succinic anhydride, or a combination thereof. In some embodiments, the dianhydrohexitol includes isosorbide. In other embodiments, the diacid component includes succinic acid, succinic anhydride, or a combination thereof, and the difunctional reactant includes lactide, lactic acid, or a combination thereof. In other embodiments, the dianhydrohexitol includes isosorbide, the diacid component includes succinic acid, succinic anhydride, or a combination thereof, and the difunctional reactant includes lactide, lactic acid, or a combination thereof. In one embodiment, the dianhydrohexitol tackifying agent includes at least 20% by weight dianhydrohexitol based on the molecular weight of the dianhydrohexitol tackifying agent.

In other embodiments, the dianhydrohexitol tackifying agent exhibits at least 20% biodegradation at 60 days when tested according to the Biodegradation Test Method. In some embodiments, the dianhydrohexitol tackifying agent exhibits at least 50% biodegradation at 60 days when tested according to the Biodegradation Test Method.

In some embodiments, the dianhydrohexitol tackifying agent includes at least 90% biogenic carbon as determined according to the New Carbon Content test method.

In another aspect, the invention features an article that includes a first industrially compostable substrate, an adhesive composition disclosed herein, and a second industrially compostable substrate adhered to the first substrate through the adhesive composition.

The invention features novel dianhydrohexitol tackifying agents, some of which are biodegradable.

The invention also features hot melt adhesive compositions that are free of phase separation, exhibit good adhesive properties, and some of which are biodegradable. Other features and advantages will be apparent from the following description of the preferred embodiments and from the claims.

### Glossary

In reference to the invention, these terms have the meanings set forth below:

As used herein the term “reaction product of” does not exclude additional unrecited reactants.

As used herein the term “derived from” does not exclude additional unrecited reactants.

As used herein the term “difunctional reactant” refers to 1) cyclic esters that upon ring opening include a hydroxy functional group and a carboxy functional group, and 2) hydroxy acids.

As used herein the term “renewable resource” refers to something that is derived from a source other than petroleum.

As used herein the term “petroleum” refers to crude oil, natural gas, and bitumen.

As used herein the term “Industrially Compostable” means compostable when tested according to ASTM D6400-19 entitled, “Standard Specification for Labeling of Plastics Designed to be Aerobically Composted in Municipal or Industrial Facilities” taken in combination with ASTM D5338-15 entitled “Standard Test Method for Determining Aerobic Biodegradation of Plastic Materials Under Controlled Composting Conditions, Incorporating Thermophilic Temperatures.”

### DETAILED DESCRIPTION

### Dianhydrohexitol Tackifying Agent

The dianhydrohexitol tackifying agent includes the reaction product of a dianhydrohexitol, a diacid component, optionally a difunctional reactant (e.g., a lactide component), optionally a monofunctional end capping agent, and preferably a catalyst.

The dianhydrohexitol tackifying agent preferably is biodegradable, or even industrially compostable. The dianhydrohexitol tackifying agent preferably exhibits at least 20% biodegradation after 30 days, after 60 days, or even after 180 days, at least 50% biodegradation at 30 days, at 60 days, or even at 180 days, or even at least 90% biodegradation at 30 days, at 60 days, or even at 180 days, when tested according to the Biodegradation Test Method.

The dianhydrohexitol tackifying agent preferably includes no greater than a minimal level of acid functionality. Particularly useful dianhydrohexitol tackifying agents have an acid number no greater than 50 milligrams (mg) potassium hydroxide (KOH) per gram (g) of the tackifying agent (mg KOH/g), no greater than 30 mg KOH/g, no greater than 20 mg KOH/g, or even no greater than 10 mg KOH/g.

The dianhydrohexitol tackifying agent exhibits a glass transition temperature (Tg) of from 0° C. to 120° C., from 30° C. to 100° C., from 30° C. to 85° C., from 30° C. to 80° C., from 30° C. to 75° C., or even from 30° C. to 70° C., and a weight average molecular weight (Mw) no greater than 6000 g/mole, no greater than 5000 g/mole, or even from 1500 g/mole to 6000 g/mole.

The dianhydrohexitol tackifying agent includes at least 80%, more preferably at least 90% biogenic carbon, most preferably 100% biogenic carbon as determined according to the New Carbon Content test method.

The dianhydrohexitol tackifying agent can be nonfunctional or include hydroxy functionality, acid functionality, or both acid and hydroxy functionalities. Preferably the dianhydrohexitol tackifying agent is hydroxy functional or nonfunctional. Useful hydroxy functional dianhydrohexitol tackifying agents include a molar ratio of dianhydrohexitol to diacid of at least 1:1, at least 1.1:1, or even at least 1.15:1 Useful nonfunctional dianhydrohexitol tackifying agents include the reaction product of the dianhydrohexitol, the diacid component, a monofunctional end capping agent, and optionally a difunctional reactant that includes a cyclic ester, a hydroxy acid, or both. The monofunctional end capping agent reacts with functional groups present in the reaction mixture thereby decreasing the functionality of the resulting dianhydrohexitol tackifying agent. The monofunctional end capping agent can be included in the reaction mixture used to form dianhydrohexitol tackifying agent, added in a second step in the reaction process after a functional dianhydrohexitol tackifying agent is formed, or both.

Suitable dianhydrohexitols from which the dianhydrohexitol tackifying agent can be derived include, e.g., isosorbide (i.e., 1,4:3,6-dianhydro-D-glucidol), isomannide (i.e., 1,4:3,6-dianhydro-D-mannitol), isoidide (i.e., 1,4:3,6-dianhydro-L-iditol), and combinations thereof. The dianhydrohexitol tackifying agent includes at least 20% by weight, no greater than 70% by weight, from 20% by weight to 70% by weight, or even from 30% by weight to 60% by weight dianhydrohexitol.

Suitable diacid components from which the dianhydrohexitol tackifying agent can be derived include dicarboxylic acids and cyclic anhydrides including, e.g., oxalic acid, succinic acid, glutaric acid, maleic acid, succinic anhydride, glutaric anhydride, maleic anhydride, 1,4-cyclohexyl dicarboxylic acid, malonic acid, adipic acid, hexahydrophthalic acid, isophthalic acid, terephthalic acid, phthalic acid, phthalic anhydride, and combinations thereof. Particularly useful diacid components include succinic acid and succinic anhydride.

Suitable difunctional reactants from which the dianhydrohexitol tackifying agent can be derived include, e.g., cyclic esters (e.g., lactides, lactones (e.g., caprolactones), lactone derivatives, and combinations thereof), hydroxy acids (e.g., 2-hydroxy propanoic acid (i.e., lactic acid), 6-hydroxy caproic acid, glycolic acid, 3-hydroxy pentanoic acid, 3-hydroxy butyric acid, 4-hydroxy butyric acid, and combinations thereof), and combinations thereof. When the dianhydrohexitol tackifying agent is derived from a difunctional reactant, the molar ratio of dianhydrohexitol to the difunctional reactant is greater than one. Useful dianhydrohexitol tackifying agents include less than 35 mole % of the difunctional reactant.

Suitable monofunctional end capping agents from which the dianhydrohexitol tackifying agent can be derived include a functional group such as hydroxyl, acid, amine, and thiol. Examples of useful end capping agents include alcohols (e.g., substituted and unsubstituted alcohols) including, e.g., ethanol, propanol, butanol, pentanol, hexanol, benzyl alcohol, rosin alcohol, and combinations thereof, monoacids (e.g., rosin acid, benzoic acid, and acetic acid), monoamines (e.g., n-butylamine), and combinations thereof.

Suitable catalysts include, e.g., antimony trioxide, antimony diethanol, tin, tin chloride, stannous octanoate, dibutyltin dilaurate, zinc chloride, tetrabutyl titanate, tetrapropyl titanate, tetraethyl titanate, triethanolamine titanate, and combinations thereof. The catalyst can be used in any suitable amount including, e.g., from 1×10⁻⁵ moles to 1×10⁻³ moles of catalyst per mole of total monomer.

Specific examples of useful dianhydrohexitol tackifying agents include dianhydrohexitol/diacid component/lactide, dianhydrohexitol/diacid component/caprolactone, dianhydrohexitol/diacid component/caprolactone/lactide, isosorbide/diacid component/lactide, isosorbide/diacid component/caprolactone, isosorbide/diacid component/caprolactone/lactide, dianhydrohexitol/succinic acid/lactide, dianhydrohexitol/succinic acid/caprolactone, dianhydrohexitol/succinic acid/caprolactone/lactide, isosorbide/succinic acid/lactide, isosorbide/succinic acid/caprolactone, isosorbide/succinic acid/caprolactone/lactide, and combinations thereof.

One useful dianhydrohexitol tackifying agent includes the reaction product of dianhydrohexitol, diacid component, and a difunctional reactant that includes cyclic ester, hydroxy acid, or a combination thereof, and has a molar ratio of dianhydrohexitol to difunctional reactant of greater than one, a Tg of from 0° C. to 120° C., or even from 30° C. to 100° C., a weight average molecular weight (Mw) of no greater than 6000, an acid number of no greater than 50 mg KOH/g.

Another useful dianhydrohexitol tackifying agent includes the reaction product of dianhydrohexitol, diacid component, and a difunctional reactant that includes lactide, lactic acid, or a combination thereof, and has a molar ratio of dianhydrohexitol to difunctional reactant of greater than one, a Tg of from 0° C. to 120° C., or even from 30° C. to 100° C., a Mw of no greater than 6000, an acid number of no greater than 50 mg KOH/g.

Another useful dianhydrohexitol tackifying agent includes the reaction product of dianhydrohexitol, diacid component, and caprolactone, and has a molar ratio of dianhydrohexitol to caprolactone of greater than one, a Tg of from 0° C. to 120° C., or even from 30° C. to 100° C., a Mw of no greater than 6000, an acid number of no greater than 50 mg KOH/g.

Other useful dianhydrohexitol tackifying agents include the reaction product of dianhydrohexitol, a succinic acid component (e.g., succinic acid, succinic anhydride, or a combination thereof), and a difunctional reactant that includes lactide, lactic acid, or a combination thereof, and has a molar ratio of dianhydrohexitol to difunctional reactant of greater than one, a Tg of from 0° C. to 120° C., or even from 30° C. to 100° C., a Mw of no greater than 6000, an acid number of no greater than 50 mg KOH/g.

Another useful dianhydrohexitol tackifying agent includes the reaction product of dianhydrohexitol, a succinic acid component (e.g., succinic acid, succinic anhydride, or a combination thereof), and caprolactone, and has a molar ratio of dianhydrohexitol to caprolactone of greater than one, a Tg of from 0° C. to 120° C., or even from 30° C. to 100° C., a Mw of no greater than 6000, an acid number of no greater than 50 mg KOH/g.

Another useful dianhydrohexitol tackifying agent includes the reaction product of isosorbide, a succinic acid component (e.g., succinic acid, succinic anhydride, or a combination thereof), a difunctional reactant that includes lactide, lactic acid, or a combination thereof, and a monofunctional end capping agent, and has a molar ratio of dianhydrohexitol to difunctional reactant of greater than one, a Tg of from 0° C. to 120° C., or even from 30° C. to 100° C., a Mw of no greater than 6000, an acid number of no greater than 50 mg KOH/g.

Another useful dianhydrohexitol tackifying agent includes the reaction product of isosorbide, a succinic acid component (e.g., succinic acid, succinic anhydride, or a combination thereof), caprolactone, and a monofunctional end capping agent, and has a molar ratio of dianhydrohexitol to caprolactone of greater than one, a Tg of from 0° C. to 120° C., or even from 30° C. to 100° C., a Mw of no greater than 6000, an acid number of no greater than 50 mg KOH/g.

Another useful dianhydrohexitol tackifying agent includes the reaction product of dianhydrohexitol, a succinic acid component (e.g., succinic acid, succinic anhydride, or a combination thereof), caprolactone, and a lactide component (e.g., lactide, lactic acid, or a combination thereof), and has a molar ratio of dianhydrohexitol to caprolactone and the lactide component of greater than one, a Tg of from 0° C. to 120° C., or even from 30° C. to 100° C., a Mw of no greater than 6000, an acid number of no greater than 50 mg KOH/g.

### Hot Melt Adhesive Composition

Useful hot melt adhesive compositions include a thermoplastic polymer and the dianhydrohexitol tackifying agent (e.g., at least 5% by weight, at least 10% by weight, no greater than 80% by weight, no greater than 70% by weight, from 5% by weight to 80% by weight, from 12% by weight to 60% by weight, or even from 15% by weight to 50% by weight dianhydrohexitol tackifying agent). The hot melt adhesive composition preferably is biodegradable or even industrially compostable. Preferred hot melt adhesive compositions exhibit at least 20% biodegradation after 30 days, after 60 days, or even after 180 days, at least 50% biodegradation at 30 days, at 60 days, or even at 180 days, or even at least 90% biodegradation at 30 days, at 60 days, or even at 180 days, when tested according to the Biodegradation Test Method. The hot melt adhesive composition also preferably includes at least 80%, more preferably at least 90%, and most preferably 100% biogenic carbon as determined according to the New Carbon Content Test Method.

Useful hot melt adhesive compositions can be formulated to exhibit any suitable viscosity including, e.g., a viscosity of less than 10,000 centipoise (cP) at 177° C.

One useful hot melt adhesive composition includes ethylene vinyl acetate copolymer and a dianhydrohexitol tackifying agent (e.g., from 30% by weight to 80% by weight isosorbide tackifying agent) that includes the reaction product of isosorbide and a succinic acid component that is succinic acid, succinic anhydride or both, and the dianhydrohexitol tackifying agent exhibits a Tg of from 0° C. to 120° C., or even from 30° C. to 100° C., a weight average molecular weight of no greater than 6000 g/mole, and an acid number no greater than 50 mg KOH/g.

Another useful hot melt adhesive composition includes polylactic acid and a dianhydrohexitol tackifying agent (e.g., from 10% by weight to 60% by weight isosorbide tackifying agent) that includes the reaction product of isosorbide, a succinic acid component that is succinic acid, succinic anhydride or both, and a difunctional reactant that includes lactide, lactic acid, or a combination thereof, and the dianhydrohexitol tackifying agent exhibits a Tg of from 0° C. to 120° C., or even from 30° C. to 100° C., a weight average molecular weight of no greater than 6000, and an acid number no greater than 50 mg KOH/g.

### Thermoplastic Polymer

The hot melt adhesive composition can include any thermoplastic polymer (including thermoplastic elastomeric polymers) that is compatible with the dianhydrohexitol tackifying agent such that the resulting composition is free of phase separation during 24 hours of static heating at the relevant use temperature. Useful thermoplastic polymers include, e.g., polylactic acid (e.g., polylactic acid homopolymers and polylactic acid copolymers), polyglycolide (e.g., polyglycolide homopolymers and polyglycolide copolymers), polyhydroxyalkanoates, polyesters (e.g., poly caprolactone), ethylene-polar comonomer copolymers (e.g., ethylene vinyl acetate, ethylene methyl acrylate, ethylene ethyl acrylate, ethylene n-butyl acrylate, ethylene acrylic acid, ethylene methyl-methacrylate, ethylene 2-ethylhexyl acrylate, and combinations thereof), acrylates (e.g., (e.g., homo and copolymers of methyl acrylate, ethyl acrylate, methyl-methacrylate, ethyl-methacrylate, 2-ethylhexyl acrylate, butyl acrylate, and combinations thereof), polyester-polyether copolymers, thermoplastic polyurethanes (e.g., polyester urethane thermoplastic polymers), poly(butylene adipate terephthalate), poly(butylene succinate), styrenic block copolymers, and combinations thereof. Preferably the thermoplastic polymer is biodegradable or even industrially compostable.

Useful polylactic acids include polylactic acid homopolymers and polylactic acid copolymers. Suitable polylactic acids include linear polyesters of polylactic acid having a molecular weight greater than 30,000 g/mole, or even greater than 40,000 g/mole, and a lactic acid content of at least 75% by weight, or even at least 85% by weight. Useful polylactic acids are commercially available under a variety of trade designations including, e.g., under the INGEO 10200-D trade designation and the VERCET A1010X trade designation from Natureworks LLC (Minnetonka, Minnesota). The hot melt adhesive composition optionally includes from 0% by weight to 90% by weight, at least 3% by weight, at least 4% by weight, at least 5% by weight, at least 30% by weight, at least 40% by weight, at least 50% by weight, no greater than 75% by weight, from 3% by weight to 90% by weight, from 5% by weight to 70% by weight, from 30% by weight to 70% by weight, or even from 40% by weight to 60% by weight polylactic acid.

Useful ethylene vinyl acetate copolymers include a vinyl acetate content of greater than 24%, or even greater than 28%, and a melt index of at least 0.1 grams per 10 minutes (g/10 min), at least 1 g/10 min, at least 5 g/10 min, at least 10 g/10 min, or even at least 100 g/10 min. Useful ethylene vinyl acetate copolymers are commercially available under a variety of trade designations including, e.g., under the ATEVA series of trade designations from Celanese Corporation (Irving, Texas) including ATEVA 2842, ATEVA 2825A, ATEVA 2830A, and ATEVA 3342 and under the LEVAMELT series of trade designations from Arlanxeo. (The Hague, The Netherlands) including LEVAMELT 400, 450, 452, 456, 500, 600, 686, 700, and 800, and under the ELVAX series of trade designations from The Dow Chemical Company (Midland, Michigan) including ELVAX 40W. The hot melt adhesive composition optionally includes from 0% by weight to 50% by weight, at least 3% by weight, at least 4% by weight, at least 5% by weight, at least 7% by weight, from 3% by weight to 50% by weight, from 5% by weight to 50% by weight, or even from 5% by weight to 40% by weight ethylene vinyl acetate.

Suitable ethylene methyl acrylate copolymers are commercially available under the OPTEMA trade designations from Exxon Chemical (Houston, Texas). Useful ethylene methyl-methacrylate copolymers are commercially available under the ACRYFT trade designations from Sumitomo Chemical Company (Tokyo, Japan).

Suitable ethylene n-butyl-acrylate copolymers include at least 30% by weight butyl acrylate. Useful ethylene n-butyl-acrylate copolymers are commercially available under the EBANTIX EN 33150 trade designation from Repsol (Madrid, Spain).

Useful polyhydroxyalkanoates include poly-3-hydroxyvalerate, poly-4-hydroxybutyrate, copolyesters of poly-3-hydroxyvalerate and poly-4-hydroxybutyrate, and combinations thereof. The hot melt adhesive composition optionally includes from 0% by weight to 90% by weight, at least 3% by weight, at least 4% by weight, at least 5% by weight, at least 30% by weight, at least 40% by weight, at least 50% by weight, no greater than 75% by weight, from 3% by weight to 90% by weight, from 5% by weight to 70% by weight, from 30% by weight to 70% by weight, or even from 40% by weight to 60% by weight polyhydroxyalkanoate.

Useful polycaprolactones are commercially available under a variety of trade designations including, e.g., under the CAPA series of trade designations from Ingevity including CAPA 6250, CAPA 6400, and CAPA 6500. The hot melt adhesive composition optionally includes from 0% by weight to 90% by weight, at least 3% by weight, at least 4% by weight, at least 5% by weight, at least 30% by weight, at least 40% by weight, at least 50% by weight, no greater than 75% by weight, from 3% by weight to 90% by weight, from 5% by weight to 70% by weight, from 30% by weight to 70% by weight, or even from 40% by weight to 60% by weight polycaprolactone.

Useful thermoplastic polyurethanes exhibit a melt temperature of less than 130° C. and include polyester polyurethanes. Suitable polyester polyurethanes include the reaction product of a polyester and a polyisocyanate (i.e., a di-, tri- or higher order isocyanate). Useful polyesters are formed from the reaction of a polyols and an acid that includes at least two acid groups. Useful polyols include, e.g., ethylene glycol, propylene glycol, 1,4-butene glycol, polymers made from ethylene oxide, propylene oxide, butylene oxide that includes at least two free hydroxyl groups, and combinations thereof. Useful acids include di- and tri-carboxylic acids including, e.g., oxalic acid, malic acid, maleic acid, phthalic acid, terephthalic acid, pyromellitic acid and combinations thereof. Useful polyesters also are derived from hydroxy-carboxylic acid containing compounds including, e.g., hydroxy acids (e.g., lactic acid and hydroxybutyric acid), polycaprolactone diols, polyethylene glycols, and combinations thereof. Useful thermoplastic polyurethanes are commercially available under a variety of trade designations including, e.g., under the PEARLBOND series of trade designations from Lubrizol Advanced Materials Inc. (Cleveland, Ohio) including PEARLBOND 301, PEARLBOND 500, PEARLBOND 501, PEARLBOND 508, and PEARLBOND ECO-509, PEARLBOND 890, PEARLBOND 103, PEARLBOND 121, and PEARLBOND 302. The hot melt adhesive composition optionally includes from 0% by weight to 90% by weight, at least 3% by weight, at least 4% by weight, at least 5% by weight, at least 6% by weight, at least 7% by weight, at least 8% by weight, no greater than 80% by weight, from 3% by weight to 90% by weight, from 5% by weight to 70% by weight, from 7% by weight to 70% by weight, or even from 10% by weight to 60% by weight polyurethane.

Useful polyester-polyether copolymers are available under a variety of trade designations including, e.g., under the HYTREL series of trade designations from DuPont de Nemours, Inc. (Wilmington, Delaware) including the HYTREL 8800 series, the HYTREL 8700 series and the HYTREL 8900 series of polyester-polyether copolymers. The hot melt adhesive composition optionally includes from 0% by weight to 90% by weight, at least 3% by weight, at least 4% by weight, at least 5% by weight, at least 30% by weight, at least 40% by weight, at least 50% by weight, no greater than 75% by weight, from 3% by weight to 90% by weight, from 5% by weight to 70% by weight, from 30% by weight to 70% by weight, or even from 40% by weight to 60% by weight polyester-polyether copolymer.

Useful styrenic block copolymers include, e.g., triblock copolymers (e.g., styrene-butadiene-styrene (SBS), styrene-isoprene-styrene (SIS), styrene-ethylene-butylene-styrene-styrene (SEBSS), and combinations thereof), diblock copolymers (e.g., styrene-butadiene diblock copolymers, styrene-isoprene diblock copolymers, and combinations thereof), and combinations thereof.

Useful block copolymers are commercially available under a variety of trade designations including, e.g., under the KRATON series of trade designations from Kraton Corporation (Houston, Texas) including, e.g., KRATON D 1102 SBS, KRATON D 1101 SBS, KRATON D 1155 SBS, KRATON D 1192, KRATON FG 1901 SEBS, KRATON FG 1924 SEBS, KRATON MD1537 H SEBSS, and KRATON A1535 H SEBSS.

The hot melt adhesive composition includes a total thermoplastic polymer content of at least 3% by weight, at least 4% by weight, at least 5% by weight, no greater than 90% by weight, no greater than 75% by weight, from 3% by weight to 90% by weight, from 5% by weight to 70% by weight, or even from 5% by weight to 60% by weight thermoplastic polymer.

### Optional Wax

The hot melt adhesive composition optionally includes wax. Suitable classes of waxes include, e.g., castor waxes, hydroxy stearamide waxes, crop oil-derived waxes, paraffin waxes, Fischer-Tropsch waxes, polyolefin waxes (e.g., polypropylene waxes and polyethylene waxes), microcrystalline waxes, metallocene waxes, and combinations thereof. Preferably the optional wax is biodegradable or even industrially compostable.

Useful castor waxes and hydroxy stearamide waxes are available under the PARICIN trade designation from Vertellus Specialties Inc. (Indianapolis, Indiana) including PARICIN 220 and PARICIN 285.

Useful crop oil derived waxes are available under the Entrada trade designation from Advonex International (Brockville, Ontario) including ENTRADA Wax 51, ENTRADA Wax 68, and ENTRADA Wax 68X.

A variety of useful paraffin waxes are commercially available including, e.g., paraffin waxes available under the PARVAN series of trade designations from ExxonMobil Chemical Company (Houston, Texas) including, e.g., PARVAN 1580 and PARVAN 1520 paraffin waxes, and under the CALUMET series of trade designations from Calumet Specialty Products Partners, LP (Indianapolis, Indiana) including CALUMET FR-6513 paraffin wax.

Useful Fischer-Tropsch waxes are commercially available under a variety of trade designations including, e.g., the SASOLWAX series of trade designations from Sasol Wax North America Corporation (Hayward, California) including, e.g., SASOLWAX C80 Fischer-Tropsch wax, and the SARAWAX series of trade designations from Shell Corporation (Malasia) including, e.g., SHELL GTL SARAWAX SX70 and SARAWAX SX80 Fischer-Tropsch waxes.

Useful polyethylene waxes are commercially available under a variety of trade designations including, e.g., the EPOLENE series of trade designations from Westlake Chemical Corporation (Houston, Texas) including, e.g., EPOLENE N-34 and EPOLENE N-35 polyethylene waxes, and the POLYWAX series of trade designations including POLYWAX 400, POLYWAX 500, POLYWAX 600, POLYWAX 655, and POLYWAX 725 polyethylene waxes from NuCera Solutions (Houston, Texas).

Useful microcrystalline waxes are commercially available under a variety of trade designations including, e.g., the MICROSERE series of trade designations from Alfa Chemicals (United Kingdom) including MICROSERE 5999A microcrystalline wax.

The hot melt adhesive composition optionally includes from 0% to less than 35% by weight, at least 1% by weight, no greater than 25% by weight, no greater than 20% by weight, or even from 1% by weight to 15% by weight wax.

### Optional Tackifying Agent

The hot melt adhesive composition optionally includes at least one additional tackifying agent. Useful optional tackifying agents have a Ring and Ball softening point of less than 160° C. The optional tackifying agent preferably is biodegradable or even industrially compostable. Suitable classes of optional tackifying agents include, e.g., aromatic, aliphatic and cycloaliphatic hydrocarbon resins, mixed aromatic and aliphatic modified hydrocarbon resins, aromatic modified aliphatic hydrocarbon resins, and hydrogenated versions thereof; terpenes, modified terpenes and hydrogenated versions thereof; natural rosins, modified rosins, rosin esters, and hydrogenated versions thereof; polylactic acid having a weight average molecular weight less than 6000 g/mol; sucrose benzoate, and combinations thereof.

Useful aliphatic and cycloaliphatic petroleum hydrocarbon resins include aliphatic and cycloaliphatic petroleum hydrocarbon resins having Ring and Ball softening points of from about 80° C. to 160° C., the hydrogenated derivatives thereof, and combinations thereof. Specific examples of useful aliphatic and cycloaliphatic petroleum hydrocarbon resins include, e.g., branched, unbranched, and cyclic C5 resins, C9 resins, and C10 resins, and combinations thereof. Useful commercially available tackifying agents are available under a variety of trade designations including, e.g., the EASTOTAC series of trade designations from Eastman Chemical Company (Kingsport, Tennessee) including, e.g., EASTOTAC H-100R, EASTOTAC H-100W, EASTOTAC H-100L, and EASTOTAC H130W, the ESCOREZ series of trade designations from ExxonMobil Chemical Company (Houston, Texas) including, e.g., ESCOREZ 1310LC, ESCOREZ 5400, ESCOREZ 5415, ESCOREZ 5600, ESCOREZ 5615, ESCOREZ 5637, and ESCOREZ 5690, the ARKON series of trade designations from Arakawa Europe GmbH (Germany) including. e.g., ARKON P-100 hydrogenated hydrocarbon resin and ARKON P-125 alicyclic saturated hydrocarbon resin, and the RESINALL trade designation from Resinall Corp. (Severn, North Carolina) including RESINALL 030 hydrogenated hydrocarbon resin, the WINGTACK series of trade designations from Cray Valley HSC (Exton, Pennsylvania) including, e.g., WINGTACK 86 aromatically modified, C-5 hydrocarbon resin, WINGTACK EXTRA aromatically modified, C-5 hydrocarbon resin, and WINGTACK 95 aliphatic C-5 petroleum hydrocarbon resin, the PICCOTAC series of trade designations from Eastman Chemical Company (Kingsport, Tennessee) including, e.g., PICCOTAC 8095 aromatically modified, C-5 hydrocarbon resin and 1115 hydrocarbon resin, and the REGALITE and REGALREZ series of trade designations from Eastman Chemical Company including, e.g., REGALITE R1125 fully hydrogenated hydrocarbon resin and REGALREZ 1126 hydrocarbon resin.

Useful rosin-based tackifying agents include rosin acids, rosin esters, wood rosin, tall oil rosin, gum rosin, distilled rosin, hydrogenated rosin, dimerized rosin, polymerized rosin, and combinations thereof. Examples of useful rosin esters include e.g., glycerol esters of pale wood rosin, glycerol esters of hydrogenated rosin, glycerol esters of polymerized rosin, pentaerythritol esters of natural and modified rosins including pentaerythritol esters of pale wood rosin, pentaerythritol esters of hydrogenated rosin, pentaerythritol esters of tall oil rosin, phenolic-modified pentaerythritol esters of rosin, and combinations thereof.

Useful commercially available rosin-based tackifying agents are available under a variety of trade designations including, e.g., the SYLVALITE series of trade designations from Arizona Chemical Company (Jacksonville, Florida) including, e.g., SYLVALITE RE-100L rosin ester, SYLVALITE 9100 rosin ester, KOMOTAC KA100L gum rosin pentaerythritol ester from Komo Pine Chemicals, Guangzhou Komo Chemical Co., Ltd. (China), the WESTREZ and ALTATAC series of trade designations from Ingevity Corp. (North Charleston, South Carolina) including, e.g., WESTREZ 5101, WESTREZ 5295, and ALTATAC 1000 rosin esters, the FORAL series of trade designations from Eastman (Kingsport, Tennessee) including, e.g., FORAL 105-E gum rosins and FORAL AX rosin acid, and the TECKROS series of trade designations from Teckrez Inc. (Fleming Island, Florida) including, e.g., TECKROS D85 and D95 rosin esters.

Examples of useful polyterpene resins include terpene phenolic resins, non-hydrogenated polyterpene resins, hydrogenated polyterpene resins, and copolymers and terpolymers of natural terpenes (e.g., styrene-terpene, alpha-methyl styrene-terpene and vinyl toluene-terpene), and combinations thereof. Polyterpene resins are commercially available under a variety of trade designations including, e.g., the SYLVARES series of trade designations from Kraton Corp. (Houston, Texas) including SYLVARES 6100 terpene resin, and under the DERCOLYTE series of trade designations from DRT Company (Dax, France) including, e.g., DERCOLYTE A115 terpene resin.

Useful low molecular weight polylactic acid tackifying agents are disclosed in U.S. Pat. No. 5,753,724 (Edgington et al.) and U.S. Pat. No. 6,365,680 (Edgington et al.) and incorporated herein.

The hot melt adhesive composition optionally includes from 0% to less than 30% by weight, at least 1% by weight, no greater than 25% by weight, from 5% by weight to 20% by weight, or even from 5% by weight to 10% by weight optional additional tackifying agent.

### Optional Plasticizer

The adhesive composition optionally includes a plasticizer, preferably a plasticizer that has been derived from a renewable resource and is biodegradable or even industrially compostable. Useful plasticizers include, e.g., solid plasticizers (e.g., benzoates) and liquid plasticizers. Useful classes of plasticizers include, e.g., oils, oligomeric and low molecular weight polymeric plasticizers, and combinations thereof.

Useful oils derived from renewable resources include, e.g., animal oil, plant oil (e.g., canola oil, corn oil, soybean oil, epoxidized soybean oil, palm oil, peanut oil, olive oil, sunflower oil, rapeseed oil, jatropha oil, coconut oil, and castor oil), lactic acid derivatives, and derivatives, and modified versions thereof, and combinations thereof.

Other useful oils include, e.g., naphthenic oils, paraffinic oils (e.g., cycloparaffin oils), mineral oils, polyesters, phthalate esters (e.g., butyl benzyl phthalate), adipate esters, synthetic liquid oligomers of polyolefins (e.g., oligomers of polypropylene, polybutene, polyisoprene, and hydrogenated polyisoprene), liquid polyisobutylene, polybutadiene, glycerol esters of fatty acids, polyesters (e.g., polyethylene glycol di-2-ethylhexoate ester, dibutyl sebacate, and diisobutyl sebacate), polyethers, triglycerides, hydrocarbon fluids, polycaprolactone diols, benzoate esters (e.g., ethylene glycol dibenzoate, propylene glycol dibenzoate, diethylene glycol dibenzoate, dipropylene glycol dibenzoate, pentaerythritol tetrabenzoate), and derivatives thereof, and combinations thereof.

Useful plasticizers are commercially available under a variety of trade designations including, e.g., HALLGREEN R-8010 renewable ester, PARAPLEX A-8000, and PARAPLEX A-8200 from Hallstar Industrial (Chicago, Illinois), BENZOFLEX 352 solid plasticizer, BENZOFLEX 284, BENZOFLEX 9-88, and BENZOFLEX 2088 from Eastman Chemical Co. (Kingsport, Tennessee), CALSOL 5550 naphthenic oil and DRAKEOL 35 paraffinic oil, from Calumet Specialty Products Partners, LP (Indianapolis, Indiana), and PURETOL 35 paraffinic oil from Petro-Canada Lubricants Inc. (Ontario, Canada), CATENEX T145 paraffinic oil from Shell Oil Products US (Houston, Texas), NYFLEX 223 naphthenic oil from Nynas AB (Stockholm, Sweden), KAYDOL mineral oil from Sonneborn (Tarrytown, New York), KRYSTOL 550 mineral oil from Petrochem Carless Limited (Surrey, England), and RISELLA X430 natural gas to liquid oil from Shell Oil Products US (Houston, Texas). DYNACOLL 7250 and DYNACOLL 7230 polyester polyols from Evonik Industries AG (Essen, Germany), PALATINOL DPHP bis(2-propylheptyl) phthalate from BASF SE (Germany), and ADMEX 334F, ADMEX 770, and ADMEX 523 from Eastman Chemical Company (Kingsport, Tennessee).

When present, the hot melt adhesive composition optionally includes from 0% by weight to 70% by weight, no greater than 70% by weight, no greater than 60% by weight, no greater than 50% by weight, no greater than 40% by weight, at least 2% by weight, at least 5% by weight, at least 10% by weight, at least 20% by weight, no greater than 30% by weight, no greater than 20% by weight, no greater than 18% by weight, no greater than 15% by weight, no greater than 10% by weight, from 2% by weight to 60% by weight, from 5% by weight to 60% by weight, from 10% by weight to 60% by weight, from 20% by weight to 60% by weight, from 2% by weight to 30% by weight, from 2% by weight to 25% by weight, from 2% by weight to 20% by weight, from 2% by weight to 15% by weight, or even from 2% by weight to 10% by weight plasticizer.

### Additional Components

The hot melt adhesive composition optionally includes a variety of additional components including, e.g., antioxidants, stabilizers, adhesion promoters, ultraviolet light stabilizers, rheology modifiers, corrosion inhibitors, colorants (e.g., pigments and dyes), fillers, flame retardants, nucleating agents, and combinations thereof.

Useful antioxidants include, e.g., pentaerythritol tetrakis[3,(3,5-di-tert-butyl-4-hydroxyphenyl)propionate], 2,2′-methylene bis(4-methyl-6-tert-butylphenol), phosphites including, e.g., tris-(p-nonylphenyl)-phosphite (TNPP) and bis(2,4-di-tert-butylphenyl)4,4′-diphenylene-diphosphonite, di-stearyl-3,3′-thiodipropionate (DSTDP), and combinations thereof. Suitable antioxidants are commercially available under a variety of trade designations including, e.g., the IRGANOX series of trade designations including, e.g., IRGANOX 1010, IRGANOX 565, and IRGANOX 1076 hindered phenolic antioxidants, and IRGAFOS 168 phosphite antioxidant, all of which are available from BASF Corporation (Florham Park, New Jersey), and ETHYL 702 4,4′-methylene bis(2,6-di-tert-butylphenol). When present, the hot melt adhesive composition preferably includes from about 0.1% by weight to about 2% by weight antioxidant.

### Uses

The hot melt adhesive composition can be applied to a substrate in any useful form including, e.g., a coating (e.g., a continuous or discontinuous coating), a film (e.g., a continuous or discontinuous film), a bead, fibers, in a pattern (a spray pattern), randomly, and combinations thereof, using any suitable application method including, e.g., slot coating, spray coating (e.g., spiral spray, random spraying, and random fiberization (e.g., melt blowing)), foaming, extrusion (e.g., applying a bead, fine line extrusion, single screw extrusion, and twin screw extrusion), wheel application, noncontact coating, contacting coating, gravure, engraved roller, roll coating, transfer coating, screen printing, flexographic, and combinations thereof.

The hot melt adhesive composition can be formulated to bond a variety of substrates used in packaging including, e.g., cardboard, coated cardboard, paperboard, fiber board, virgin and recycled kraft, high and low density kraft, chipboard, treated and coated kraft and chipboard, and corrugated versions of the aforementioned, clay coated chipboard carton stock, composites, leather, polymer film (e.g., polyolefin, polyester, polylactic acid, polyhydroxyalkanoates, metalized polymer films, multi-layer films, and combinations thereof), substrates made from fibers (e.g., virgin fibers, recycled fibers, and combinations thereof), and combinations thereof.

The hot melt adhesive composition can be formulated to bond a variety of substrates used in disposable articles including, e.g., woven and nonwoven webs (e.g., webs made from fibers (e.g., yarn, thread, filaments, microfibers, blown fibers, and spun fibers), webs made from films, perforated films, tape backings, fibers, substrates (e.g., woven webs and nonwoven webs), release liners, porous substrates, sheets, paper products, labels, other substrates used in diapers, feminine hygiene articles (e.g., sanitary napkins), adult incontinence articles, containers, and combinations thereof.

The various substrates, fibers, films, webs, sheets, backings, liners, and articles can be derived from a variety of sources including, e.g., polyolefin (e.g., polypropylene and polyethylene), nylon, rayon, polyester (e.g., polyethylene terephthalate), polylactic acid, polyhydroxyalkanoates, starch, polyvinyl chloride, polyurethane, acrylate, cotton, viscose, cellulose, carboxymethyl cellulose, starch, starch derivatives, silk, wool, glass, and combinations thereof.

The various substrates, fibers, films, and webs can be derived from renewable resources including renewable resources derived from, e.g., plants (e.g., corn, bamboo, rice, cotton, wood, beets, potatoes, beans, sugar cane, and fruit), animals, fish, bacteria, fungi, and combinations thereof, specific examples of which include carboxymethyl cellulose, Guar Gum, alginate, starch, viscose, polylactic acids, polyhydroxyalkanoates, and combinations thereof.

The hot melt adhesive composition is useful for forming adhesive bonds in a variety of articles including, e.g., boxes, cartons, trays, cases, articles that include attachments (e.g., straws attached to drink boxes), ream wrap, cigarettes (e.g., plug wrap), filters (e.g., filter pleating and filter frames), bags (e.g., multiwall bags), composites that include chipboard laminated to metal foil (e.g., aluminum foil) and optionally laminated to at least one layer of polymer film, composites that include chipboard bonded to polymer film, composites that include Kraft bonded to film, and combinations thereof.

The hot melt adhesive composition is also useful for forming adhesive bonds in a variety of disposable articles including, e.g., medical drapes, medical gowns, sheets, feminine hygiene articles, diapers, adult incontinence articles, and absorbent pads (e.g., for animals (e.g., pet pads) and humans (e.g., bodies and corpses)).

Particularly useful articles include compostable substrates, optionally derived from renewable resources, adhered together through the adhesive composition.

The invention will now be described by way of the following examples. All parts, ratios, percentages, and amounts stated in the Examples are by weight unless otherwise specified.

### EXAMPLES

### Test Procedures

Test procedures used in the examples include the following. All ratios and percentages are by weight unless otherwise indicated. The procedures are conducted at room temperature (i.e., an ambient temperature of from about 20° C. to about 25° C.) unless otherwise specified.

### Biodegradation Test Method

The biodegradation of a sample is determined according to ASTM D5338-15 entitled, “Standard Test Method for Determining Aerobic Biodegradation of Plastic Materials Under Controlled Composting Conditions, Incorporating Thermophilic Temperatures.” The percentage of aerobic biodegradation, per paragraph 14.1.5, at the specified period of time, is determined and reported as the percent biodegradation at that period of time.

### Acid Number Test Method

Acid number is determined according to ASTM D664-07 entitled, “Standard Test Method for Acid Number of Petroleum Products by Potentiometric Titration.”

### Compatibility Test Method

The composition is heated to the specified temperature, held at the specified temperature for 24 hours, and then observed with the naked eye to determine if phase separation is present. If no phase separation is present, the components in the composition are determined to be compatible.

### Viscosity Test Method

Viscosity is determined at the specified temperature in accordance with ASTM D-3236 entitled, “Standard Test Method for Apparent viscosity of Hot Melt Adhesives and Coating Materials,” (Oct. 31, 1988), using a Brookfield viscometer (e.g., a Brookfield RVDV-II+), a Brookfield Thermosel heated sample chamber, and a number 27 spindle. The results are reported in centipoise (cP).

### Method for Determining Molecular Weight

Number average molecular weight (Mn) and weight average molecular weight (Mw) are determined using size-exclusion chromatography (SEC).

### Sample Preparation

Approximately 0.08 g of a sample is mixed with 5 mL tetrahydrofuran (THF) and shaken using a shaker for two hours. The samples are then filtered through a 0.45 μm polytetrafluoroethylene (PTFE) filter.

### Mn and Mw Determination Test Method

Low Molecular Weight SEC: SEC is performed using THF as the eluent at 30° C. and two 7.5 mm (inner diameter), 300 mm (length) MESOPORE SEC columns held at 30° C., an ultraviolet light (UV) detector set to 254 nm and 300 nm followed by a refractive index (RI) detector. The system is calibrated using polystyrene standards having Mws ranging from 0.370 kDa to 2580 kDa. The UV and RI detectors are connected in series. The sample passes through the UV detector 0.2 min before it is detected by the RI detector. The elution time from the UV trace is adjusted to overlay the RI/UV data. To overlay the UV and RI traces for comparison, approximately 0.2 min is added to the elution time of the UV trace. The resulting values are reported in grams per mole (g/mol).

### Glass Transition Temperature (Tg) Test Method

Glass Transition Temperature (Tg) is determined using differential scanning calorimetry (DSC) according to ASTM D-3418-99 entitled, “Transition Temperatures of Polymers by Thermal Analysis” and ASTM E-794-06 entitled, “Standard Test Method for Melting and Crystallization Temperatures by Thermal Analysis,” using the following conditions: heating to 180° C. from −20° C. at a rate of 20° C. per minute, holding at 180° C. for 1 minutes (the first heating cycle), then cooling to −20° C. from 180° C. at a rate of 20° C. per minute, holding at −20° C. for 1 minutes, and then heating then from −20° C. to 180° C. at a rate of 20° C. per minute (the second heating cycle). The Tg is obtained from the second heating cycle and is reported as the Tg of the sample. The results are reported in degrees Celsius (° C.).

### Peel Test Sample Preparation Method I

A slot coating applicator (applying a one on, one off 1:1 pattern), which is 3 inch (76.2 mm) wide, and a laminator are set to an application temperature of from 110° C. to 120° C., a nip pressure of 34.5 kilopascal (5 psi), an application weight of 6 g/m², and minimal rewind and unwind tensions so as not to stretch the web.

The hot melt adhesive composition is applied continuously at a coat weight of 6 g/m² on a polylactic acid nonwoven web having a thickness of 0.1 mm and a basis weight of 15 g/m² as the nonwoven web is passed through the applicator at a speed of from 190 meters per minute (m/min) to 230 m/min with 5 mm deflection. A breathable polyethylene film having a thickness of 0.23 mm, traveling at the same speed as the nonwoven web, is then nipped into place against the adhesive composition and the nonwoven web to form a laminate.

### Peel Test Sample Preparation Method II

The peel test samples are prepared as described in Method I above with the exception that the coat weight is 10 g/m².

### Dynamic Peel Adhesion Test Method

Dynamic peel adhesion is determined according to ASTM D1876-01 entitled, “Test Method for Determining Peel Resistance of Adhesive (T-Peel Test Method),” with the exception that the test is run at 30.5 centimeters per minute (12 inches per minute) over a period of 10 seconds and 8 replicates are run. The test samples are run on an IMASS Spec-type test instrument. The test samples are prepared as described in the Peel Test Sample Preparation Method I or IL as specified. Eight test samples are prepared for each sample composition and the test samples are tested 24 hours after the test sample has been prepared. The average peel value over 10 seconds of peeling is recorded, and the results are reported in units of Newtons per centimeter (N/cm).

### New Carbon Content Test Method

New carbon content is determined according to ASTM D6866-22 Method B (AMS) TOC entitled “Standard Test Methods for Determining the Biobased Content of Solid, Liquid, and Gaseous Samples Using Radiocarbon Analysis,” and reported as % biogenic carbon.

### Process for Preparing Isosorbide Tackifying Agent

Diacid and isosorbide are added to a four-port flask with mixing. Mixing is continued throughout the reaction process. The air in the system is replaced with nitrogen. Then the temperature is increased to from 120° C. to 150° C. The catalyst is then added to the system. After the reactants are completely dissolved, the temperature is increased to from 190° C. to 230° C. and the reactants are allowed to react for from 3 hours to 8 hours during which time the generated water is removed. The nitrogen is then turned off. A vacuum is then turned on and the vacuum is slowly reduced to 20 mbar over a period of 2 hours. The reaction is allowed to proceed for from 2 hours to 6 hours under 20 mbar of pressure. The reaction is then stopped, and the product is allowed to cool to room temperature.

### Isosorbide Tackifying Agent 2

Isosorbide tackifying agent 2 was prepared by adding 82.67 g of succinic acid and 112.45 g of isosorbide to a four-port flask with mixing. Mixing was continued throughout the reaction process. The air in the system was replaced with nitrogen and then the temperature was increased to 140° C. until the reaction mixture melted. Then, 0.98 g antimony trioxide was added to the system. After the reactants dissolved, the temperature was increased to 190° C., and the mixture was allowed to react for 3 hours. Water generated during the reaction was removed from the flask upon generation. After three hours, the nitrogen was turned off and a vacuum was turned on. The vacuum was slowly reduced to 20 mbar over a period of 2 hours. The reaction was allowed to continue for an additional 3 hours at 20 mbar. The reaction was then stopped. The product was allowed to cool to room temperature and yielded a white transparent solid product that had a molar ratio of isosorbide to succinic acid of 1.1:1, a Tg of 64° C., a weight average molecular weight of 2109, and an acid number of 5.6 mg KOH/g.

### Isosorbide Tackifying Agents 1 and 3-6

Isosorbide Tackifying Agents 1 and 3-6 were prepared according to the method disclosed in Isosorbide Tackifying Agent 2 with the exception that the amounts of isosorbide, diacid, and catalyst were altered to as to achieve a tackifying agent having the molar ratio, Mw, and acid number set forth in Table 1 and the diacid used to form the tackifying agent was as specified in Table 1.

### Isosorbide Tackifying Agent 10

Isosorbide tackifying agent 10 was prepared by adding 826.70 g of succinic acid, 1125.43 g of isosorbide, and 288.0 g lactide to a four-port flask with mixing. Mixing was continued throughout the reaction process. The air in the system was replaced with nitrogen and then the temperature was increased to 130° C. Then, 9.70 g of tetrabutyl titanate was added to the system. After the reactants dissolved, the temperature was increased to 200° C., and the mixture was allowed to react for three hours. Water generated during the reaction was removed from the flask upon generation. After the three hours, the nitrogen was turned off and a vacuum was turned on. The vacuum was slowly reduced to 20 mbar over a period of 2 hours. The reaction was allowed to continue for an additional four hours under 20 mbar of pressure. The reaction was then stopped. The product was then allowed to cool to room temperature and yielded a white transparent solid product that had a molar ratio of isosorbide to succinic acid to lactide molar ratio of 1.1:1:0.3, a Tg of 56° C., a weight average molecular weight of 3529, and an acid number of 20.1 mg KOH/g.

### Isosorbide Tackifying Agents 7-9

Isosorbide Tackifying Agents 7-9 were prepared according to the method disclosed in Isosorbide Tackifying Agent 10 with the exception that the amounts of isosorbide, succinic acid, lactide, and catalyst were altered so as to achieve a tackifying agent having the molar ratio, Mw, and acid number set forth in Table 1.

TABLE 1

| | | Molar | | | Acid |
|---|---|---|---|---|---|
| | | Ratio of | Tg | Mw | Number |
| Tackifier | Monomers | Monomers | (° C.) | (g/mole) | (mg KOH/g) |
| 1 | I, SA | 1.2:1 | 36 | 1917 | 32 |
| 2 | I, SA | 1.1:1 | 64 | 2109 | 5.6 |
| 3 | I, CHA | 1.2:1 | 65 | 1605 | ND |
| 4 | I, CHA | 1.1:1 | 84 | 4202 | ND |
| 5 | I, SA, CHA | 1.1:0.5:0.5 | 57 | 2474 | ND |
| 6 | I, SA | 1.1:1 | 48 | NT | 30.3 |
| 7 | I, SA, L | 1.1:1:0.3 | 56 | 3473 | 15.8 |
| 8 | I, SA, L | 1.1:1:0.5 | 57 | 4258 | 14.3 |
| 9 | I, SA, L | 1.1:1:0.5 | 52 | 3445 | 20.1 |
| 10 | I, SA, L | 1.1:1:0.3 | 56 | 3529 | 20.1 |

I = isosorbide
SA = succinic acid
CHA = 1,4-cyclohexyl dicarboxylic acid
L = lactide
NT = not tested

### Isosorbide Tackifying Agents 11-13

Isosorbide Tackifying Agents 11-13 were prepared according to the process described in the preparation of Isosorbide Tackifying Agent 2 with the exception that the reaction temperatures were as specified in Table 2. The resulting isosorbide tackifying agents were tested according to the Tg and Acid Number test methods and the results are reported in Table 2.

TABLE 2

| | | Reaction | | Acid |
|---|---|---|---|---|
| Tackifying | | Temperature | Tg | Number |
| Agent | I:SA | (° C.) | (° C.) | (mg KOH/g) |
| 11 | 1.1:1 | 190 | 57.97 | 15.07 |
| 12 | 1.1:1 | 200 | 62.94 | 12.47 |
| 13 | 1.1:1 | 230 | 65.32 | 8.73 |

### Isosorbide Tackifying Agents 14-17

Isosorbide Tackifying Agents 14-17 were prepared according to the process described in the preparation of Isosorbide Tackifying Agent 2 with the exception that the reaction temperature was 230° C. and the period of time during which the reaction took place after the system reached 20 mbar was as specified in Table 3. The resulting isosorbide tackifying agents were tested according to the Acid Number test method and the results are reported in Table 3.

TABLE 3

| | Reaction time | Acid Number |
|---|---|---|
| Tackifier | (hours) | (mg KOH/g) |
| 14 | 2 | 10.61 |
| 15 | 4 | 2.54 |
| 16 | 5 | 1.43 |
| 17 | 6 | 0.89 |

### Isosorbide Tackifying Agent 18

Isosorbide tackifying agent 18 was prepared by adding 82.67 g of succinic acid and 112.45 g of isosorbide to a four-port flask with mixing. Mixing was continued throughout the reaction process. The air in the system was replaced with nitrogen and then the temperature was increased to 140° C. until the reaction mixture melted. Then, 0.98 g antimony trioxide was added to the system. After the reactants dissolved, the temperature was increased to 190° C., and the mixture was allowed to react for 3 hours. Water generated during the reaction was removed from the flask upon generation. After three hours, the nitrogen was turned off and a vacuum was turned on. The vacuum was slowly reduced to 20 mbar over a period of 2 hours. The reaction was allowed to continue for an additional 3 hours at 20 mbar. Nitrogen was then injected into the reactor to restore the system to normal pressure. Then 39.9 g caprolactone and 0.035 g tin isooctanoate were added to the system and the mixture was allowed to react at 190° C. for 8 hours. Then the reaction was stopped. The resulting reaction product was allowed to cool to room temperature and yielded a white transparent solid product that had a molar ratio of isosorbide to succinic acid to caprolactone of 1.1:1:0.5, a Tg of 13.42° C., a weight average molecular weight of 5232 g/mole, and an acid number of 14.1 mg KOH/g. Information about isosorbide tackifying agent 18 is summarized in Table 4.

### Isosorbide Tackifying Agent 19

Isosorbide tackifying agent 19 was prepared by adding 73.22 g of succinic acid, 13.29 g terephthalic acid, and 112.54 g of isosorbide to a four-port flask with mixing. Mixing was continued throughout the reaction process. The air in the system was replaced with nitrogen and then the temperature was increased to 130° C. Then, 0.97 g of tetrabutyl titanate was added to the system. After the reactants dissolved, the temperature was increased to 200° C., and the mixture was allowed to react for three hours. Water generated during the reaction was removed from the flask upon generation. After three hours, the nitrogen was turned off and a vacuum was turned on. The vacuum was slowly reduced to 20 mbar over a period of 2 hours. The reaction was allowed to continue for an additional four hours under 20 mbar of pressure. The reaction was then stopped. The reaction product was then allowed to cool to room temperature and yielded a white transparent solid product that had a molar ratio of isosorbide to succinic acid to terephthalic acid of 1.1:0.89:0.11, a Tg of 65.67° C., a weight average molecular weight of 2888 g/mole, and an acid number of 15.02 mg KOH/g. Information about isosorbide tackifying agent 19 is summarized in Table 4.

TABLE 4

| | | Molar | | | Acid |
|---|---|---|---|---|---|
| | | Ratio of | Tg | Mw | Number |
| Tackifier | Monomers | Monomers | (° C.) | (g/mole) | (mg KOH/g) |
| 18 | I, SA, CAP | 1.1:1.0:0.5 | 13.42 | 5232 | 14.1 |
| 19 | I, SA, TA | 1.1:0.89:0.11 | 65.67 | 2888 | 15.02 |

CAP = caprolactone
TA = terephthalic acid

### Biodegradation of Isosorbide Tackifying Agent 1

Isosorbide Tackifying Agent 1 was tested according to the Biodegradation Test Method with the exception that the samples were tested in duplicate instead of the triplicate required by the test method, the amount of inoculum was 300 g, and the amount of sample was 25 g. The average percent biodegradation, based on the two samples, after the periods specified in Table 5, is set forth below in Table 5.

TABLE 5

| Days of Testing | Average % Biodegradation |
|---|---|
| 30 | 35.9 |
| 45 | 49.0 |
| 60 | 61.9 |
| 70 | 70.6 |
| 86 | 83.3 |
| 93 | 85.2 |

### New Carbon Content Isosorbide Tackifying Agent 1

Isosorbide Tackifying Agent 1 was tested according to the New Carbon Content test method and was determined to have 100% biogenic carbon content.

### Examples 1-6

The hot melt adhesive compositions of Examples 1-6 were prepared as follows: components of the hot melt adhesive compositions of Examples 1-6 were combined at room temperature in the amounts set forth in Table 6 (in percent by weight), then heated to a temperature sufficient to melt the components (i.e., from 160° C. to 180° C., and then mixed at a temperature of from 170° C. to 180° C. to form the adhesive composition. The resulting hot melt adhesive compositions were then tested according to the Viscosity test method. The results are set forth below in Table 6.

TABLE 6

| | 1 | 2 | 3 | 4 | 5 | 6 |
|---|---|---|---|---|---|---|
| EVA1 | 30 | 30 | 30 | 0 | 0 | 0 |
| EVA2 | 0 | 0 | 0 | 35 | 35 | 35 |
| Tackifier 2 | 50 | 0 | 0 | 45 | 0 | 0 |
| Tackifier 3 | 0 | 50 | 0 | 0 | 45 | 0 |
| Tackifier 5 | 0 | 0 | 50 | 0 | 0 | 45 |
| SX-105 | 19.5 | 19.5 | 19.5 | 0 | 0 | 0 |
| PARVAN | 0 | 0 | 0 | 19.5 | 19.5 | 19.5 |
| 1580 | | | | | | |
| IRGANOX | 0.5 | 0.5 | 0.5 | 0.5 | 0.5 | 0.5 |
| 1010 | | | | | | |
| Viscosity at | 5163 | 3705 | 3370 | 4055 | 4120 | 5225 |
| 177° C. (cP) | | | | | | |
| *% Fiber | | | | | | |
| Tear After | | | | | | |
| 24 hours at | | | | | | |
| 23° C. | 90 | 90 | 70 | >95 | >95 | >95 |
| 4° C. | 70 | 85 | 85 | >95 | >95 | >95 |
| −18° C. | N.T | N.T. | N.T. | >95 | >95 | >95 |

EVA1 = ATEVA 2842 AC ethylene vinyl acetate copolymer having a melt index of 400 g/10 min at 190° C. using a 2.16 kilogram weight according to ASTM D 1238 and a vinyl acetate content of 28% as reported by the manufacturer (Celanese Corporation, Irving, Texas)
EVA2 = ATEVA 3342 ethylene vinyl acetate copolymer having a melt index of 400 g/10 min at 190° C. using a 2.16 kg weight according to ASTM D 1238 and a vinyl acetate content of 33% as reported by the manufacturer (Celanese Corporation)
SX-105 = Fischer-Tropsch wax (Evonik Corp., Parsippany, New Jersey)
PARVAN 1580 = paraffin wax (ExxonMobil Corp., Houston, Texas)
IRGANOX 1010 = antioxidant
* Fiber tear was determined by applying a bead of molten adhesive composition (0.5 cm in width) at a temperature from 170° C. to 180° C. on a piece of WESTROCK 44 paper substrate, and after two seconds, mating the adhesive with a second WESTROCK 44 paper substrate and applying a force of 0.2 pounds per square inch for 10 seconds. The sample was then conditioned at the specified temperature for 24 hours, after which the paper substrates were immediately pulled away from one another. The area of one side of the adhesive composition covered by fibers was observed and the results were reported in percent based on the total area of that side of the adhesive.

### Examples 7-12

The hot melt adhesive compositions of Examples 7-12 were prepared according to the process described in Examples 1-6 using the components and amounts set forth in Table 7 (in percent by weight). The resulting hot melt adhesive compositions were then tested according to at least one of the Viscosity, Compatibility, and Dynamic Peel test methods. The results are set forth below in Table 7.

TABLE 7

| Example | 7 | 8 | 9 | 10 | 11 | 12 |
|---|---|---|---|---|---|---|
| INGEO 10200D | 30.5 | 30.5 | 30.5 | 30.5 | 30.5 | 30.5 |
| HALLGREEN | 45.5 | 45.5 | 45.5 | 45.5 | 40.5 | 49.0 |
| R8010 | | | | | | |
| PARICIN 220 | 3.5 | 3.5 | 3.5 | 3.5 | 3.5 | 0 |
| IRGANOX 1010 | 0.5 | 0.5 | 0.5 | 0.5 | 0.5 | 0.5 |
| Tackifier 1 | 0 | 0 | 0 | 20 | 15 | 0 |
| Tackifier 6 | 20 | 0 | 0 | 0 | 0 | 0 |
| Tackifier 9 | 0 | 0 | 0 | 0 | 0 | 20 |
| Tackifier 10 | 0 | 20 | 0 | 0 | 0 | 0 |
| Tackifier 11 | 0 | 0 | 20 | 0 | 0 | 0 |
| Sucrose Benzoate | 0 | 0 | 0 | 0 | 10 | 0 |
| Tg (° C.) | 10 | 14 | 13 | 14 | 21 | 0 |
| Viscosity at | 2780 | 5720 | 3875 | 3415 | 9815 | 1050 |
| 107° C. (cP) | | | | | | |
| Compatibility at | Yes | Yes | Yes | Yes | Yes | NT |
| 107° C./24 hours | | | | | | |
| (Lack of visible | | | | | | |
| phase separation) | | | | | | |
| Dynamic Peel | >0.29 | >0.22 | >0.17 | NT | 0.65 | NT |
| (N/cm) | | | | | | |
| 6 g/m² coat | | | | | | |
| weight | | | | | | |
| Dynamic Peel | >0.54 | >0.31 | >0.28 | NT | 1.16 | NT |
| (N/cm) | | | | | | |
| 10 g/m² coat | | | | | | |
| weight | | | | | | |

Sucrose Benzoate = MIRAMAR SB sucrose benzoate (Miwon Chemical, South Korea)
INGEO 10200D = polylactic acid (Natureworks, LLC, Minnetonka, Minnesota)
HALLGREEN R8010 = polymeric ester (Hallstar Industrial, Chicago, Illinois)
PARICIN 220 = paraffin wax (Vertellus Specialties Inc., Indianapolis, Indiana)
IRGANOX 1010 = antioxidant
NT = not tested

### Biodegradation of Example 7

The hot melt adhesive composition of Example 7 was tested according to the Biodegradation Test Method with the exception that the test was conducted in duplicate instead of the triplicate required by the test method, the amount of inoculum was 600 g, and the amount of sample was 35 g to 38 g. The average percent biodegradation, based on the two samples, after the periods specified in Table 8, is set forth below in Table 8.

TABLE 8

| Days of Testing | Average % Biodegradation |
|---|---|
| 18 | 54.5 |
| 25 | 73.1 |
| 30 | 81.7 |
| 45 | 87.9 |
| 53 | 89.3 |
| 67 | 91.6 |
| 102 | 93.8 |
| Testing Stopped | |

Other embodiments are within the claims. Although the dianhydrohexitol tackifying agent has been described as being useful as a tackifying agent in a hot melt adhesive composition, it is also useful as a polymer additive. As an additive, the dianhydrohexitol tackifying agent can function as a flow modifier to a thermoplastic polymer, such that the dianhydrohexitol tackifying agent decreases the melt viscosity of the thermoplastic polymer to which it is added. As an additive, the dianhydrohexitol-based tackifying agent can be used in combination with a thermoplastic polymer without appreciably altering the characteristics of the thermoplastic polymer and optionally without imparting tack to the polymer. For these reasons, the dianhydrohexitol tackifying agent described above is referred to herein as a dianhydrohexitol additive when utilized in polymer compositions that are not necessarily adhesive compositions.

The resulting polymer composition preferably is biodegradable or even industrially compostable. Useful polymer compositions exhibit at least 20% biodegradation after 30 days, after 60 days, or even after 180 days, at least 50% biodegradation at 30 days, at 60 days, or even at 180 days, or even at least 90% biodegradation at 30 days, at 60 days, or even at 180 days, when tested according to the Biodegradation Test Method.

The dianhydrohexitol additive is a useful additive to a variety of thermoplastic polymers including, e.g., polylactic acid (e.g., polylactic acid homopolymers and polylactic acid copolymers), polyglycolide (e.g., polyglycolide homopolymers and polyglycolide copolymers), polyhydroxyalkanoates, polyesters (e.g., cyclic polyesters (e.g., polycaprolactone)), ethylene-polar comonomer copolymers (e.g., ethylene vinyl acetate, ethylene methyl acrylate, ethylene ethyl acrylate, ethylene n-butyl acrylate, ethylene acrylic acid, ethylene methyl-methacrylate, ethylene 2-ethylhexyl acrylate, and combinations thereof), acrylates (e.g., homo and copolymers of methyl acrylate, ethyl acrylate, methyl-methacrylate, ethyl-methacrylate, 2-ethylhexyl acrylate, butyl acrylate, and combinations thereof), thermoplastic polyurethanes (e.g., polyester urethane thermoplastic polymers), poly(butylene adipate terephthalate), poly(butylene succinate), polyester-polyether copolymers, styrenic block copolymers, and combinations thereof. Suitable thermoplastic polymers and commercially available examples of the same include the polymers and commercially available polymers set forth above under the Hot Melt Adhesive Composition section. Preferably the thermoplastic polymer is biodegradable or even industrially compostable.

The dianhydrohexitol additive is a useful additive to a thermoplastic polymer to form a thermoplastic polymer composition that includes at least 1% by weight, at least 2% by weight, at least 3% by weight, from 1% by weight to 30% by weight, from 2% by weight to 25% by weight, from 10% by weight to 20% by weight, from 5% by weight to 15% by weight, or even from 1% by weight to 10% by weight dianhydrohexitol additive, and at least 75% by weight, at least 80% by weight, from 70% by weight to 99% by weight, from 80% by weight to 99% by weight, or even from 85% by weight to 95% by weight thermoplastic polymer.

Such polymer compositions are suitable for use in forming a variety of articles including, e.g., fibers, films, nonwovens, packaging (trays and clam shell packages), cutlery, and drinking cups, using a variety of processes including, e.g., injection molding.

1. A hot melt adhesive composition that includes from 3% by weight to 90% by weight polymer; and from 10% by weight to 80% by weight of a dianhydrohexitol tackifying agent comprising the reaction product of dianhydrohexitol, a diacid component selected from the group consisting of dicarboxylic acid, cyclic anhydride, and combinations thereof, optionally a difunctional reactant selected from the group consisting of cyclic ester, hydroxy acid, and combinations thereof, when the difunctional reactant is present, the dianhydrohexitol tackifying agent has a molar ratio of dianhydrohexitol to difunctional reactant of greater than one, and optionally a monofunctional end capping agent, the dianhydrohexitol tackifying agent exhibiting a glass transition temperature (Tg) of from 30° C. to 100° C., a weight average molecular weight of no greater than 6000, and an acid number no greater than 50 mg KOH/g.

2. The hot melt adhesive composition of paragraph 1, wherein the dianhydrohexitol tackifying agent exhibits a Tg of from 30° C. to 100° C.

3. The hot melt adhesive composition of paragraphs 1 or 2, wherein the dianhydrohexitol tackifying agent comprises the reaction product of the dianhydrohexitol, the diacid component, and the difunctional reactant.

4. The hot melt adhesive composition of paragraph 3, wherein the difunctional reactant is selected from the group consisting of lactide, lactic acid, caprolactone, 6-hydroxy caproic acid, glycolic acid, 3-hydroxy pentanoic acid, 3-hydroxy butyric acid, 4-hydroxy butyric acid, and combinations thereof.

5. The hot melt adhesive composition of any one of paragraphs 1-3, wherein the difunctional reactant comprises lactide, lactic acid, or a combination thereof.

6. The hot melt adhesive composition of any one of paragraphs 1-5, wherein the dianhydrohexitol tackifying agent comprises the reaction product of the dianhydrohexitol, the diacid component, and the monofunctional end capping agent.

7. The hot melt adhesive composition of any one of paragraphs 1-6, wherein the polymer is selected from the group consisting of ethylene polar comonomer copolymer, polylactic acid, polyhydroxyalkanoate, polyurethane, poly(butylene adipate terephthalate), poly(butylene succinate), polycaprolactone, polycaprolactone copolymers, polyester-polyether copolymer, acrylates, and combinations thereof.

8. The hot melt adhesive composition of any one of paragraphs 1-7, wherein the dianhydrohexitol tackifying agent is hydroxy functional.

9. The hot melt adhesive composition of any one of paragraphs 1-8, wherein the dianhydrohexitol tackifying agent has an acid number less than 30 mg KOH/g.

10. The hot melt adhesive composition of any one of paragraphs 1-8, wherein the dianhydrohexitol tackifying agent has an acid number less than 10 mg KOH/g.

11. The hot melt adhesive composition of any one of paragraphs 1-10, wherein the diacid component is selected from the group consisting of oxalic acid, glutaric acid, maleic acid, succinic acid, succinic anhydride, glutaric anhydride, maleic anhydride, 1,4-cyclohexyl dicarboxylic acid, malonic acid, adipic acid, hexahydrophthalic acid, isophthalic acid, terephthalic acid, phthalic acid, phthalic anhydride, and combinations thereof.

12. The hot melt adhesive composition of any one of paragraphs 1-10, wherein the diacid component comprises succinic acid, succinic anhydride, or a combination thereof.

13. The hot melt adhesive composition of any one of paragraphs 1-12, wherein the dianhydrohexitol comprises isosorbide.

14 The hot melt adhesive of any one of paragraphs 1-13, wherein the hot melt adhesive composition comprises from 10% by weight to 50% by weight of the dianhydrohexitol tackifying agent.

15. The hot melt adhesive of any one of paragraphs 1-6 and 8-14, wherein the polymer comprises ethylene vinyl acetate and the hot melt adhesive composition comprises from 30% by weight to 80% by weight of the dianhydrohexitol tackifying agent.

16. The hot melt adhesive of any one of paragraphs 1-6 and 8-14, wherein the polymer comprises polylactic acid and the hot melt adhesive composition comprises from 10% by weight to 60% by weight of the dianhydrohexitol tackifying agent.

17 The hot melt adhesive of any one of paragraphs 1-16, wherein the dianhydrohexitol tackifying agent exhibits a Tg of from 30° C. to 70° C.

18. The hot melt adhesive of any one of paragraphs 1-17, wherein the dianhydrohexitol tackifying agent is derived from at least 20% by weight dianhydrohexitol based on the molecular weight of the dianhydrohexitol tackifying agent.

19. The hot melt adhesive of any one of paragraphs 1-18, wherein the hot melt adhesive composition exhibits at least 20% biodegradation at 60 days when tested according to the Biodegradation Test Method.

20. The hot melt adhesive of any one of paragraphs 1-18, wherein the hot melt adhesive composition exhibits at least 50% biodegradation at 60 days when tested according to the Biodegradation Test Method.

21. The hot melt adhesive of any one of paragraphs 1-18, wherein the hot melt adhesive composition exhibits at least 80% biodegradation at 90 days when tested according to the Biodegradation Test Method.

22. The hot melt adhesive of any one of paragraphs 1-18, wherein the hot melt adhesive composition exhibits at least 90% biodegradation at 180 days when tested according to the Biodegradation Test Method.

23. The hot melt adhesive composition of any one of paragraphs 1-22, wherein the tackifying agent includes at least 90% biogenic carbon as determined according to the New Carbon Content test method.

24. A thermoplastic polymer composition comprising: from 50% by weight to 99% by weight of a polymer selected from the group consisting of polylactic acid, polyglycolide, polyhydroxyalkanoate, polyurethane, poly(butylene adipate terephthalate), poly(butylene succinate), polycaprolactone, ethylene-polar comonomer copolymer, polyester-polyether copolymer, acrylate, methacrylate, and combinations thereof; and from 1% by weight to 50% by weight dianhydrohexitol additive, the dianhydrohexitol additive having a weight average molecular weight of no greater than 6000 g/mole, and a glass transition temperature of from 30° C. to 100° C., and the dianhydrohexitol additive comprising the reaction product of dianhydrohexitol, a diacid component selected from the group consisting of dicarboxylic acid, cyclic anhydride, and combinations thereof, optionally a difunctional reactant selected from the group consisting of cyclic ester, hydroxy acid, and combinations thereof, and optionally a monofunctional end capping agent, the dianhydrohexitol additive having an acid number no greater than 50 mg KOH/g, and, when the difunctional reactant is present, a molar ratio of dianhydrohexitol to the difunctional reactant of greater than 1.

25. The polymer composition of paragraph 24, wherein the dianhydrohexitol tackifying agent exhibits a Tg of from 30° C. to 100° C.

26. The polymer composition of any one of paragraphs 24 and 25, wherein the composition exhibits at least 90% biodegradation at 180 days when tested according to the Biodegradation Test Method.

27. A dianhydrohexitol tackifying agent comprising: the reaction product of dianhydrohexitol, a diacid component selected from the group consisting of dicarboxylic acid, cyclic anhydride, and combinations thereof, a difunctional reactant selected from the group consisting of cyclic ester, hydroxy acid, and combinations thereof, and optionally a monofunctional end capping agent, the dianhydrohexitol tackifying agent comprising at least 20% by weight dianhydrohexitol, having a molar ratio of dianhydrohexitol to difunctional reactant of greater than one, and exhibiting a glass transition temperature of from 0° C. to 120° C., a weight average molecular weight of no greater than 6000, and an acid number of no greater than 50 mg KOH/g.

28. The dianhydrohexitol tackifying agent of paragraph 27, wherein the tackifying agent exhibits a Tg of from 30° C. to 100° C.

29. The dianhydrohexitol tackifying agent of any one of paragraphs 27 and 28, wherein the difunctional reactant is selected from the group consisting of lactide, lactic acid, caprolactone, 6-hydroxy caproic acid, glycolic acid, 3-hydroxy pentanoic acid, 3-hydroxy butyric acid, 4-hydroxy butyric acid, and combinations thereof.

30. The dianhydrohexitol tackifying agent of any one of paragraphs 27 and 28, wherein the difunctional reactant comprises lactide, lactic acid, or a combination thereof.

31. The dianhydrohexitol tackifying agent of any one of paragraphs 27-30, wherein the diacid component comprises succinic acid, succinic anhydride, or a combination thereof.

32. The dianhydrohexitol tackifying agent of any one of paragraphs 27-31, wherein the dianhydrohexitol comprises isosorbide.

33. The dianhydrohexitol tackifying agent of any one of paragraphs 27, 28, and 32, wherein the diacid component comprises succinic acid, succinic anhydride, or a combination thereof, and the difunctional reactant comprises lactide, lactic acid, or a combination thereof.

34. The dianhydrohexitol tackifying agent of any one of paragraphs 27-33, wherein the dianhydrohexitol tackifying agent comprises at least 20% by weight dianhydrohexitol based on the molecular weight of the dianhydrohexitol tackifying agent.

35. The dianhydrohexitol tackifying agent of any one of paragraphs 27-34, wherein the dianhydrohexitol tackifying agent exhibits at least 20% biodegradation at 60 days when tested according to the Biodegradation Test Method.

36. The dianhydrohexitol tackifying agent of any one of paragraphs 27-34, wherein the dianhydrohexitol tackifying agent exhibits at least 50% biodegradation at 60 days when tested according to the Biodegradation Test Method.

37. The dianhydrohexitol tackifying agent of any one of paragraphs 27-36, wherein the dianhydrohexitol tackifying agent comprises at least 90% biogenic carbon as determined according to the New Carbon Content test method.

38. The dianhydrohexitol tackifying agent of any one of paragraphs 27-37, wherein the dianhydrohexitol tackifying agent comprises a molar ratio of dianhydrohexitol to diacid of at least 1:1.

39. An article comprising: a first compostable substrate; the hot melt adhesive composition of any one of paragraphs 1-23; and a second compostable substrate adhered to the first substrate through the adhesive composition.

What is claimed is:

1. A hot melt adhesive composition comprising:
from 3% by weight to 90% by weight polymer; and
from 10% by weight to 80% by weight of a dianhydrohexitol tackifying agent comprising the reaction product of
dianhydrohexitol,
a diacid component selected from the group consisting of dicarboxylic acid, cyclic anhydride, and combinations thereof,
optionally a difunctional reactant selected from the group consisting of cyclic ester, hydroxy acid, and combinations thereof, when the difunctional reactant is present, the dianhydrohexitol tackifying agent has a molar ratio of dianhydrohexitol to difunctional reactant of greater than one, and
optionally a monofunctional end capping agent,
the dianhydrohexitol tackifying agent exhibiting a glass transition temperature (Tg) of from 30° C. to 100° C., a weight average molecular weight of no greater than 6000, and an acid number no greater than 50 mg KOH/g.

2. The hot melt adhesive composition of claim 1 further comprising wax.

3. The hot melt adhesive composition of claim 1, wherein the tackifying agent comprises at least 90% biogenic carbon as determined according to the New Carbon Content test method.

4. The hot melt adhesive composition of claim 1, wherein the dianhydrohexitol tackifying agent comprises the reaction product of the dianhydrohexitol, the diacid component, and the difunctional reactant.

5. The hot melt adhesive composition of claim 4, wherein the difunctional reactant is selected from the group consisting of lactide, lactic acid, caprolactone, 6-hydroxy caproic acid, glycolic acid, 3-hydroxy pentanoic acid, 3-hydroxy butyric acid, 4-hydroxy butyric acid, and combinations thereof.

6. The hot melt adhesive composition of claim 1, wherein the dianhydrohexitol tackifying agent comprises the reaction product of the dianhydrohexitol, the diacid component, and the monofunctional end capping agent.

7. The hot melt adhesive composition of claim 1, wherein the polymer is selected from the group consisting of ethylene polar comonomer copolymer, polylactic acid, polyhydroxyalkanoate, polyurethane, poly(butylene adipate terephthalate), poly(butylene succinate), polycaprolactone, polycaprolactone copolymers, polyester-polyether copolymer, acrylates, and combinations thereof.

8. The hot melt adhesive composition of claim 1, wherein the dianhydrohexitol tackifying agent has an acid number less than 30 mg KOH/g.

9. The hot melt adhesive composition of claim 1, wherein the diacid component is selected from the group consisting of oxalic acid, glutaric acid, maleic acid, succinic acid, succinic anhydride, glutaric anhydride, maleic anhydride, 1,4-cyclohexyl dicarboxylic acid, malonic acid, adipic acid, hexahydrophthalic acid, isophthalic acid, terephthalic acid, phthalic acid, phthalic anhydride, and combinations thereof.

10. The hot melt adhesive composition of claim 1, wherein the diacid component comprises succinic acid, succinic anhydride, or a combination thereof.

11. The hot melt adhesive composition of claim 1, wherein the dianhydrohexitol comprises isosorbide.

12. The hot melt adhesive of claim 1, wherein the polymer comprises ethylene vinyl acetate and the hot melt adhesive composition comprises from 30% by weight to 80% by weight of the dianhydrohexitol tackifying agent, or the polymer comprises polylactic acid and the hot melt adhesive composition comprises from 10% by weight to 60% by weight of the dianhydrohexitol tackifying agent.

13. The hot melt adhesive of claim 1, wherein the hot melt adhesive composition exhibits a property selected from the group consisting of at least 90% biodegradation at 180 days when tested according to the Biodegradation Test Method, at least 90% biogenic carbon as determined according to the New Carbon Content test method, and combinations thereof.

14. A thermoplastic polymer composition comprising:
from 50% by weight to 99% by weight of a polymer selected from the group consisting of polylactic acid, polyglycolide, polyhydroxyalkanoate, polyurethane, poly(butylene adipate terephthalate), poly(butylene succinate), polycaprolactone, ethylene-polar comonomer copolymer, polyester-polyether copolymer, acrylate, methacrylate, and combinations thereof, and
from 1% by weight to 50% by weight dianhydrohexitol additive, the dianhydrohexitol additive having a weight average molecular weight of no greater than 6000 g/mole, and a glass transition temperature of from 30° C. to 100° C., and
the dianhydrohexitol additive comprising the reaction product of dianhydrohexitol, a diacid component selected from the group consisting of dicarboxylic acid, cyclic anhydride, and combinations thereof, optionally a difunctional reactant selected from the group consisting of cyclic ester, hydroxy acid, and combinations thereof, and optionally a monofunctional end capping agent,
the dianhydrohexitol additive having
an acid number no greater than 50 mg KOH/g, and,
when the difunctional reactant is present, a molar ratio of dianhydrohexitol to the difunctional reactant of greater than 1.

15. A dianhydrohexitol tackifying agent comprising:
the reaction product of
dianhydrohexitol,
a diacid component selected from the group consisting of dicarboxylic acid, cyclic anhydride, and combinations thereof,
a difunctional reactant selected from the group consisting of cyclic ester, hydroxy acid, and combinations thereof, and
optionally a monofunctional end capping agent,
the dianhydrohexitol tackifying agent
comprising at least 20% by weight dianhydrohexitol,
having a molar ratio of dianhydrohexitol to difunctional reactant of greater than one, and
exhibiting a glass transition temperature (Tg) of from 0° C. to 120° C., a weight average molecular weight of no greater than 6000, and an acid number of no greater than 50 mg KOH/g.

16. The dianhydrohexitol tackifying agent of claim 15, wherein the tackifying agent exhibits a Tg of from 30° C. to 100° C.

17. The dianhydrohexitol tackifying agent of claim 15, wherein the dianhydrohexitol tackifying agent exhibits a property selected from the group consisting of at least 90% biogenic carbon as determined according to the New Carbon Content test method, at least 90% biodegradation at 180 days when tested according to the Biodegradation test method, and combinations thereof.

18. The dianhydrohexitol tackifying agent of claim 15, wherein the difunctional reactant is selected from the group consisting of lactide, lactic acid, caprolactone, 6-hydroxy caproic acid, glycolic acid, 3-hydroxy pentanoic acid, 3-hydroxy butyric acid, 4-hydroxy butyric acid, and combinations thereof.

19. The dianhydrohexitol tackifying agent of claim 15, wherein the diacid component comprises succinic acid, succinic anhydride, or a combination thereof.

20. The dianhydrohexitol tackifying agent of claim 15, wherein the dianhydrohexitol comprises isosorbide.

21. An article comprising:
a first compostable substrate;
the hot melt adhesive composition of claim 1; and
a second compostable substrate adhered to the first substrate through the adhesive composition.
